(19) United States
(12) Patent Application Publication
(10) Pub. No.: US 2025/0361892 A1
(43) Pub. Date: Nov. 27, 2025

(54) REDUCED SKIN-FRICTION DRAG SURFACE TEXTURES AND MATERIALS, DESIGNS, METHODS AND SYSTEMS

(71) Applicant: University of Southern California, Los Angeles, CA (US)

(72) Inventors: Anita Penkova, Los Angeles, CA (US); Francisco Jose Del Campo Melchor, Los Angeles, CA (US); Boris Fritz, Los Angeles, CA (US); Marty Bradley, Los Angeles, CA (US)

(21) Appl. No.: 18/874,556

(22) PCT Filed: Jun. 15, 2023
(86) PCT No.: PCT/US2023/068545

§ 371 Date: Dec. 12, 2024

Related U.S. Application Data
(60) Provisional application No. 62/352,577, filed on Jun. 21, 2016.

(51) Int. Cl. F15D 1/00; B63B 1/36; B64C 21/10; F15D 1/12

(52) U.S. Cl. CPC F15D 1/0045; F15D 1/12; B63B 1/36; B64C 21/10

(57) ABSTRACT

An object or a vehicle is disclosed that is configured for moving through a fluid or for relative movement of a fluid past the object, the fluid comprising air or water, the object or vehicle further comprising: a structure having a surface, wherein the surface is exposed to the fluid as the vehicle moves through the fluid; and the surface having a surface texture comprising a wave structure transverse to a principal direction of flow of the fluid over the surface, wherein the surface texture is configured to reduce skin-friction drag on the vehicle or object. A material is disclosed that is configured for use on a surface of a vehicle for the purpose of reducing skin-friction drag. A method is disclosed for reducing skin-friction drag on a vehicle, the method comprising forming a wavelike pattern on a surface of a structure.

### PRIORITY CLAIM

This application claims priority to U.S. provisional patent application No. 63/352,577, titled “BIOMIMETIC ENGINEERED DOLPHIN SKIN INSPIRED MATERIALS TO REDUCE SKIN-FRICTION DRAG”, filed Jun. 15, 2022. The '577 disclosure is incorporated here by reference in its entirety for all purposes.

### FIELD

Disclosed herein are materials, designs, and/or methods/systems for determining and using the same, for the purposes of reducing skin-friction drag in connection with fluid flow over a surface, such as over the surface of a vehicle, such as cars, trucks, boats, or airplanes, or over the surfaces of other objects.

### BACKGROUND

Skin-friction drag is often undesirable. A reduction in drag will typically increase efficiency. In particular, the transportation industry is continuously striving to improve efficiency and save costs, decrease pollution, and comply with new environmentally friendly regulations. One way to do so is to reduce drag. For subsonic or supersonic aircraft, skin-friction drag accounts for 50% and 40%, respectively, of total vehicle drag. Therefore, approximately half of the required power during cruise of a subsonic jet transport is dedicated to overcoming this skin-friction drag, demonstrating the potential fuel efficiency increase if a solution to this issue were developed. In at least one example, research into how sea lions reduce the skin-friction drag on their “walls” has led to a significant reduction in skin-friction drag for heavy trucks by applying the concept of active compliant walls mechanisms used by sea lions. But further improvement generally in the field of reducing skin-friction drag could still be very beneficial. Thus, a strong need exists for materials, systems, and methods for reducing skin-friction drag.

### SUMMARY

In accordance with an example embodiment, a vehicle is disclosed that is configured for moving through a fluid, the fluid comprising air or water, the vehicle further comprising: a structure having a surface, wherein the surface is exposed to the fluid as the vehicle moves through the fluid; and the surface having a surface texture comprising a wave structure transverse to a principal direction of flow of the fluid over the surface, wherein the surface texture is configured to reduce skin-friction drag on the vehicle as it travels through the fluid.

In accordance with another example embodiment, a material is disclosed that is configured for use on a surface of a vehicle at a location that contacts air or water as the vehicle moves for the purpose of reducing skin-friction drag of the vehicle as it travels through the air or water.

In accordance with another example embodiment, an object is disclosed that is configured to have reduced skin-friction drag, the object comprising: a surface, the surface configured for exposure to a fluid flowing relative to the surface, wherein the surface is configured to reduce skin-friction drag between the surface of the object and the fluid flowing relative to the surface; and the surface having a surface texture comprising a wave structure transverse to a principal direction of flow of the fluid over the surface.

In accordance with another example embodiment, a method is disclosed for reducing skin-friction drag on a vehicle that contacts air or water when it travels, the method comprising forming a wavelike pattern on a surface of a structure.

### BRIEF DESCRIPTION OF DRAWINGS

A more complete understanding of the present disclosure may be derived by referring to the detailed description and claims when considered in connection with the Figures, wherein like reference numbers refer to similar elements throughout the Figures, and:

FIGS. 1A and 1B illustrate shark skin and dolphin skin, in accordance with various embodiments.

FIGS. 2 is a flow diagram illustrating an exemplary method(s) for reducing drag on a structure, such as an airplane, in accordance with various embodiments.

FIGS. 3A-3F are illustrations of computational data for exemplary embodiments disclosed herein, in accordance with various embodiments.

FIG. 4 is a block diagram showing two embodiments, in accordance with example embodiments.

FIG. 5 comprises a number of views of the riblets applied to the surface of a vehicle or object, in accordance with an example embodiment.

FIG. 6 is a graph of an example fuselage drag change analysis.

### DETAILED DESCRIPTION

Types of drag can be divided into the following categories: skin-friction drag, lift-induced drag, wave drag or wave resistance, and pressure drag. The first one, skin-friction drag, is directly related to the velocity gradients of the flow inside the boundary layer near the wall. In general terms, maintenance of laminar flow for the longest possible distance over the surface is important. It is difficult to maintain laminar flow when an object moves at large velocity, or its length (chord) is large. This issue results in a reduction in laminar flow and corresponding increase in skin-friction drag in flow over the surfaces of cars, boats, airplanes, or rockets, resulting in an increase in fuel consumption and decrease in efficiency. This application is primarily concerned with skin-friction drag.

For completeness, lift-induced drag occurs as the result of generating lift on a 3-D body, such as a wing or a fuselage. Wave drag is created when a body moves in a flow near the supersonic speeds. And pressure drag is caused by the separation of the boundary layer and the wake generated by that separation, depending directly on the shape of the object.

In accordance with various example embodiments, disclosed herein are bio-inspired materials, designs, systems, and methods associated therewith based loosely on the skin of a dolphin with the objective of reducing the skin-friction drag in disparate end-use applications, while improving performance. In an example embodiment, a new surface structure and/or new materials are disclosed that may be used in end-use applications, e.g., that may include and are not limited to surfaces on vehicles or the like such as cars, trucks, boats, or airplanes.

Thus, in an example, new bio-inspired smart materials are disclosed to reduce skin-friction drag and improve the overall aerodynamic efficiency of an airplane. In an example, materials selected to reduce skin-friction drag and improve the overall aerodynamic efficiency include flexible materials and, in a preferred embodiment include polydimethylsiloxane elastomer and ethylene tetrafluoroethylene. These two proposed materials are flexible materials, meaning that the surface will adapt to the flow in which they are immersed.

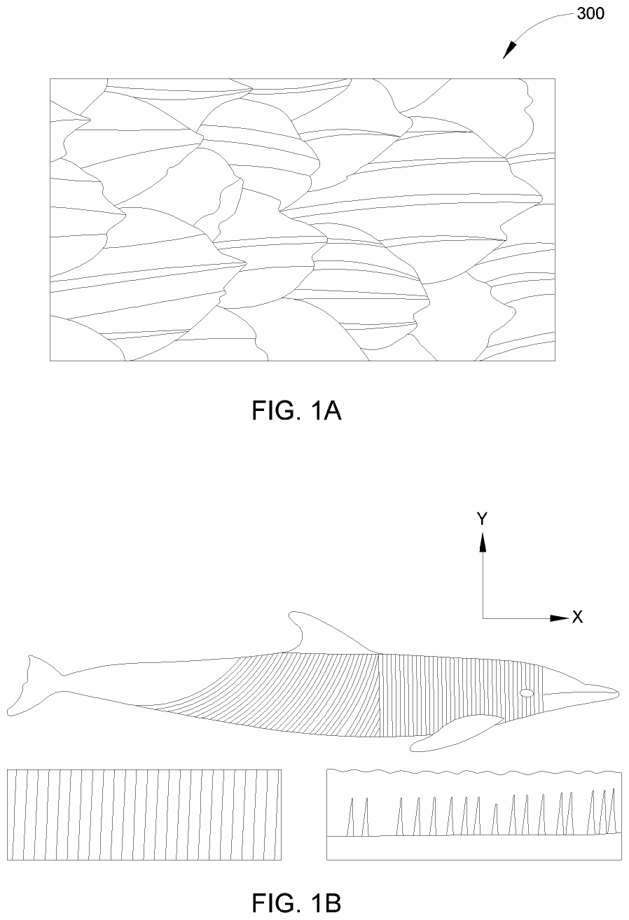

Bio-inspired design considers nature as the main originator for creating solutions to various engineering problems. Through billions of years of development and precise selection, nature has evolved and come across efficient shapes that can offer innovative solutions to different engineering problems. In fact, it has been able to create different paths in which skin-friction drag can be reduced. For instance, sailfish, birds, insects, sharks (see FIG. 1A), or dolphins have each developed unique biological mechanism to reduce skin-friction drag. The texture of shark skin, known as denticles, has captivated researchers due to its hydrodynamic advantages. Denticles are tiny, tooth-like scales that cover the skin of various shark species, creating a unique micro-topography. These denticles effectively reduce drag by controlling the flow of water over the shark's body, enabling swift and agile movement. Various attempts have been made to apply similar denticle textures to aircraft surfaces to reduce drag, to increase fuel efficiency and improve maneuverability.

Dolphin skin (See FIG. 1B) is quite different from shark skin topography. The skin of dolphins is incredibly smooth. The dolphin skin is covered in a layer of microscopic ridges and valleys that reduce skin friction, allowing dolphins to glide through water effortlessly. In an example embodiment, materials are disclosed and objects and vehicles having surface textures and/or materials inspired by the dolphin skin, but improved to more suitably reduce skin-friction drag in such end-uses.

In an example embodiment, a vehicle is configured for moving through a fluid, the fluid comprising air or water. In this embodiment, the vehicle may further comprise a structure having a surface, wherein the surface is exposed to the fluid as the vehicle moves through the fluid; and the surface has a surface texture comprising a wave structure transverse to a principal direction of flow of the fluid over the surface. In this embodiment, the surface texture is configured to reduce skin-friction drag on the vehicle as it travels through the fluid.

In an example embodiment, the fluid is air or water. In further example embodiments, the water is salt water such as in the ocean. Moreover, the fluid may be any fluid that may flow over a surface (for example the surface of a vehicle or an object) where there is a desire to reduce the skin-friction drag of the surface on the fluid.

In an example embodiment, the vehicle is an airplane. In another example embodiment, the vehicle is a helicopter, a drone, and/or any suitable flying vehicle. In another example embodiment, the vehicle is a truck, a passenger vehicle, a commercial semi-tractor and/or trailer, a race car, and/or the like. In an example embodiment, the vehicle may be a boat, ship, submarine, and/or the like. In an example embodiment, the vehicle may be configured for travel on the surface, in the air, in the water, and/or under the water. Moreover, the vehicle may be any vehicle that can benefit from reduced skin-friction drag as it passes through the fluid.

In an example embodiment, the object may be a missile, a torpedo, and/or a rocket. Moreover, the object may comprise any suitable structure that may move through and/or relative to a fluid. In further example embodiments, the object may be a windmill, inlet, fan, duct, turbine blade, impeller, and or the like. In accordance with various example embodiments, the reduced skin-friction drag may result in noise mitigation due to a reduction of turbulence in the fluid moving over a surface of the vehicle or object. In an example embodiment, the object may be a stationary object where the fluid flows past the surface of the object. For example, the object may be a tower, a pole, a bridge, or other object that may benefit from reduced wind load (because the surface may have a lower surface-friction drag relative to an object without a surface so configured) and therefor can be built less expensively without loss of safety. In another example embodiment, the object is a pipe configured with an inner surface configured for lower skin-friction drag on fluid flow within the pipe, relative to pipes without a so configured inner surface. In another example embodiment, the object is a heat exchanger pipe with an outer surface configured for lower skin-friction drag on fluid flow over the outside surface of the pipe, relative to pipes without a so configured outer surface.

In each of these examples, the surface of the vehicle or object disclosed herein is configured to improve performance of the vehicle or object relative to a vehicle or object with a surface not so configured by reducing the skin-friction drag (again reduced relative to the same vehicle or object with a surface not so configured). In an example embodiment, reducing the skin-friction drag is configured to increase the speed of the vehicle or object through the fluid without increasing the effort to propel the vehicle or object through the fluid, relative to a surface not so configured. In an example embodiment, reducing the skin-friction drag is configured to reduce the effort required to propel the vehicle or object through the fluid without reducing the speed of the object moving through the fluid, relative to a surface not so configured. In an example embodiment, reducing the skin-friction drag is configured to increase the speed of the fluid without increasing the effort to propel fluid (e.g., through the pipe or over the pipe), relative to a surface not so configured. In other embodiments, reducing the skin-friction drag is configured to reduce the effort required to propel the fluid (e.g. through the pipe or over the pipe) without reducing the velocity of the fluid, relative to a surface not so configured. Accordingly, in an example embodiment, reducing the skin-friction drag is configured to reduce carbon emissions, provide a more energy efficient solution for moving the vehicle or object through the fluid (and/or moving the fluid past the surface), relative to a surface not so configured. Thus, the solutions disclosed herein present a more sustainable, eco-friendly, and high-performance surface for vehicles and objects, as will be described in more detail herein.

In accordance with various example embodiments, the surface is a flat surface. In other example embodiments, the surface is conformal to the shape of the associated structure of the object or vehicle. For example, the surface may be conformal to that of a wing, nose cone, tail or fuselage of an airplane. In another example, the surface is conformal to the hull, keel, bow, rudder, mast or superstructure of a boat. In another example embodiment, the surface is conformal to the inner or outer surface of a pipe. In another example embodiment, the surface is conformal to the surface of a stationary structure. Moreover, the surface may be conformal to any surface over which fluid may flow and a reduction of skin-friction drag is desirable.

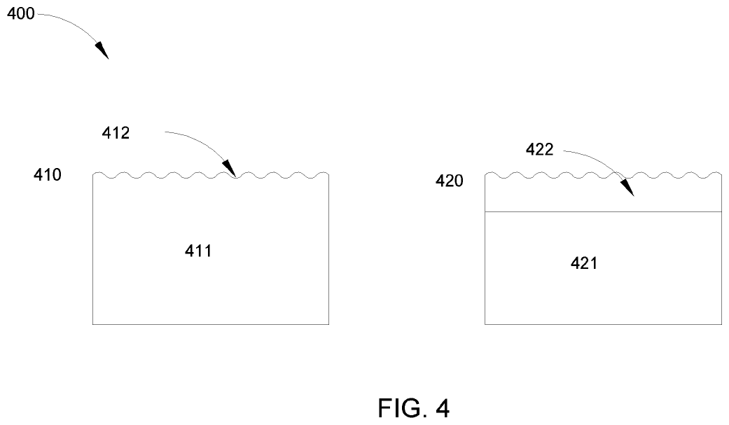

With brief reference to FIG. 4, in a first example embodiment 410, the vehicle or object comprises a structure 411 and the surface features 412 are integral with the structure. For example, a vehicle or object may comprise a structure having a surface, the surface having features formed therein and the surface being integral to the structure. In this example embodiment, the structure 411 may be formed and then the features formed in the surface through use of etching, grinding, laser oblation, and/or the like. This method would be suitable to original manufacture or retrofit of the vehicle or object. In another example embodiment, the structure 411 is formed with the surface texture embedded therein. In an example embodiment, the surface texture comprises riblets. In an example embodiment, the riblets have a parabolic shape.

In a second example embodiment 420, the vehicle or object comprises a structure having a main structure 421 and a surface layer 422. In this embodiment, the surface layer 422 is attached to the main structure. The surface layer may comprise a skin, a polymer sheet, applied paint of applied polymer, or any suitable layer having the surface texture and/or materials described herein. The surface layer 422 may be attached using adhesive, welding, and or the like, or may be bonded directly to the main structure 421.

In one example embodiment, the surface layer may be added to the main structure via methods such as additive manufacturing, 3D printing, and the like. In another example embodiment, the surface layer may be applied to the main structure such as by painting the main structure with a surface layer material, and then removing material from the painted layer via etching, grinding, laser ablation and/or the like.

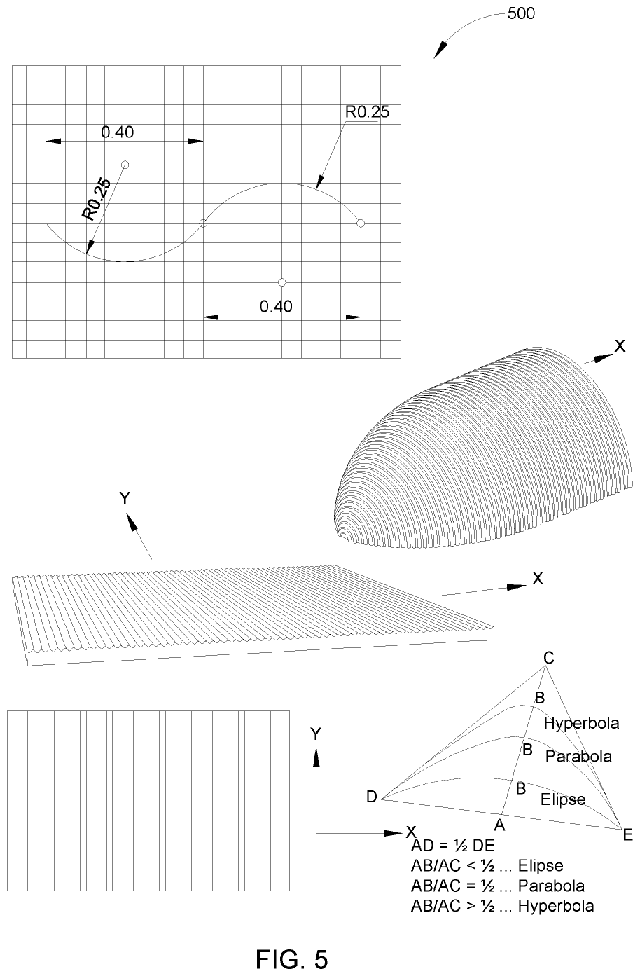

In an example embodiment, whether an integral surface or surface layer, the surface features may comprise riblets. In an example embodiment, the riblets are oriented in rows across a surface. The riblets may comprise peaks and troughs. In this example embodiment, one riblet has a peak and two associated troughs on either side of the peak. In this example embodiment, and with reference to FIG. 5, the peak and two associated troughs extend linearly in the Y direction. In this example embodiment, the anticipated fluid flow is in the X direction. Stated another way, in an example embodiment, the anticipated bulk fluid flow direction is transverse to the extended direction of the riblets. However, it is acknowledged that even bulk fluid flow may vary as a vehicle turns, as the wind varies in its direction, or for other reasons. Thus, this disclosure is not limited to a purely perpendicular flow path over the extended direction of the riblets. Thus, transverse flow may be defined to be flow that is between 30 degrees, and preferably between 15 degrees, plus or minus of the direction that is perpendicular to the riblets in a plane parallel to the surface at that point.

In an example embodiment, the riblets exhibit a smooth wave form across the surface of the structure with a parabolic waveform. In another example embodiment, the riblets are formed from piecewise linear steps approximating the parabolic waveform. In a first example embodiment, the riblets are optimized such that each trough and peak is parabolic in shape. In an example embodiment, the waveform of the riblets is parabolic. In an example embodiment, the waveform of the riblets may comprise any suitable conic shape with a rho (ρ) value (the ratio of the distance of the peak of the rounded corner to the sharp corner) between 0.40 and 0.60, preferably between 0.45 and 0.55, and most preferably between 0.47 and 0.53 (such as when the rho is .5, a perfect parabola). See FIG. 5 showing the calculation of the rho value for a parabola.

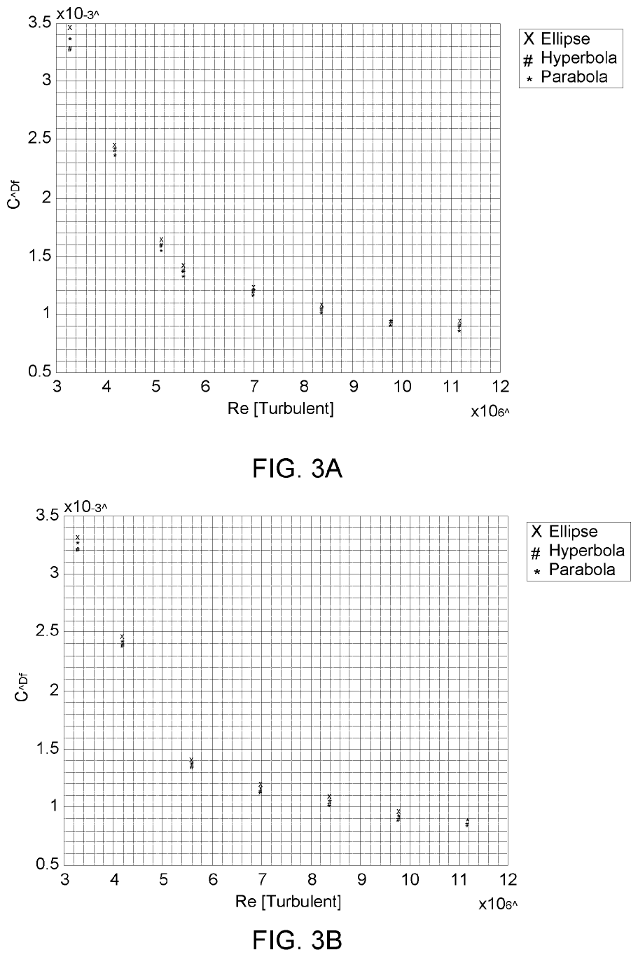

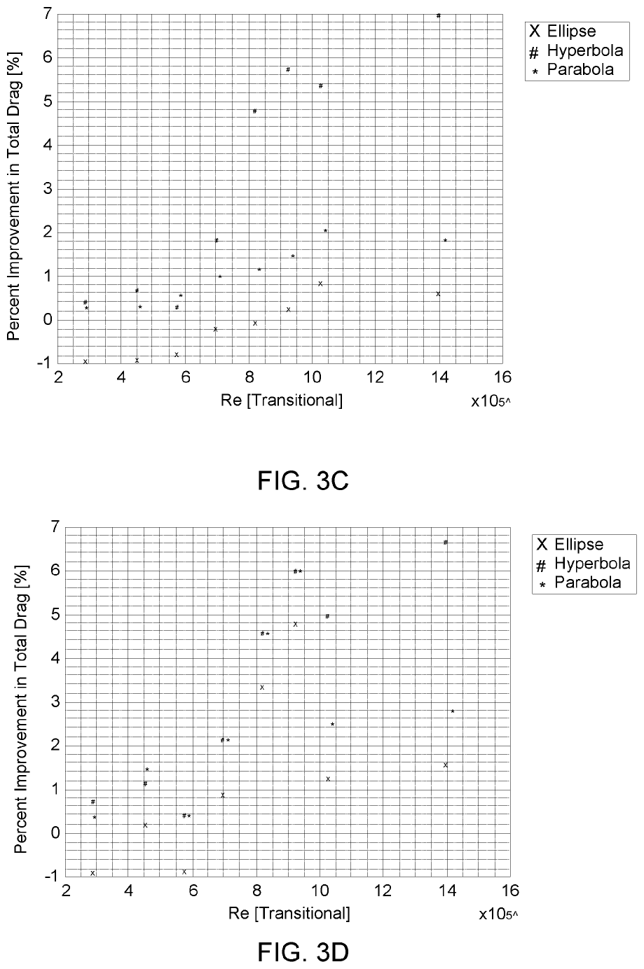

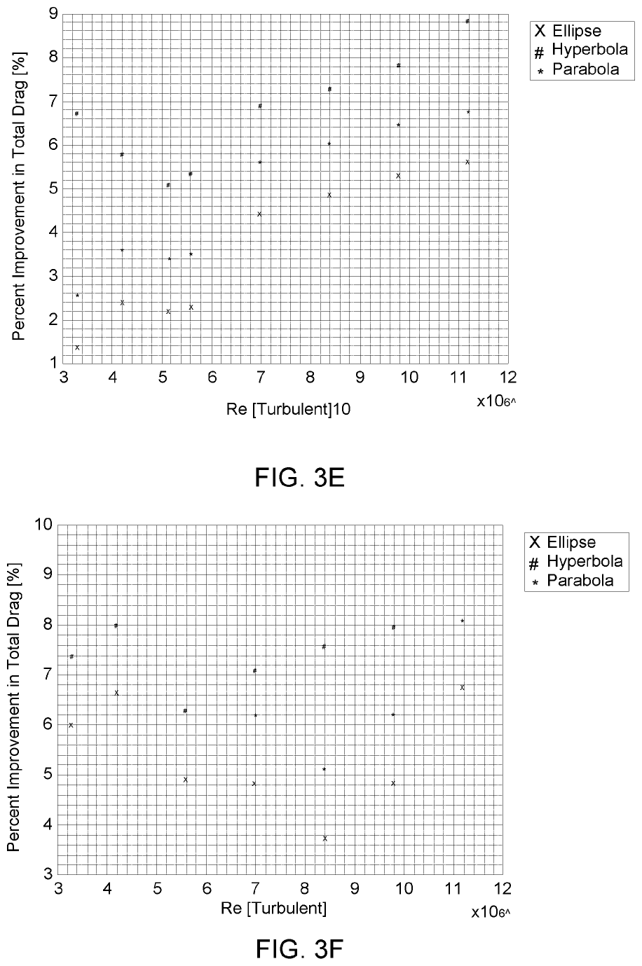

It is noted that the parabola shape provides the greatest percent improvement in total drag for Polydimethylsiloxane elastomer, FIG. 3C, and ETFE, FIG. 3D, in transitional flow, compared to hyperbola and parabola shaped waveforms. Similarly the parabola shape provides the greatest percent improvement in total drag for Polydimethylsiloxane elastomer, FIG. 3E, and ETFE, FIG. 3F, in turbulent flow, compared to hyperbola and parabola shaped waveforms. Thus, in an example embodiment, the waveform is parabolic, or nearly parabolic.

In an example embodiment, the height of the waveform, the peak to peak distance, may be between 0.025 cm and 0.25 cm. In particular, for Reynolds numbers in the laminar regime, the critical ridge height is calculated to be (h\hat{ }s/L)≅0.01. Nevertheless, the critical ridge height becomes (h\hat{ }s/L)≅0.12 due to the tendency of the turbulent boundary layer to inhibit flow separation. Above that critical number, the turbulent flow over the ridges separates, thus forming large eddies behind each one, and therefore generating an increase in the overall drag. The optimal drag reduction at a given velocity is optimal at ridge heights under the critical value.

In an example embodiment, the critical ridge ratio is used to determine the height of the peak e.g. 0.03 cm. However, any suitable critical ridge ratio may be used to determine any suitable height of the peak. In accordance with various example embodiments, the flexible material is configured to compensate for fixed ridge height with the flexible material allowing ridge height to stay below the critical value (above which turbulent flow begins to start de-attaching and forming large stationary eddies behind each ridge that will effectively lower the ridge height and significantly increase drag). Deformation of the ridges at higher flow speeds results in a decrease in ridge height and increase in drag reduction.

In an example embodiment, the critical ridge values (the ratio between the height and the length of each ridge), are 0.01 for the laminar regime and 0.12 for the turbulent regime. However, any suitable critical ridge values may be used. In an example embodiment, steady state conditions such as thrust output may be used to calculate for riblet dimensions.

In one example embodiment, the surface textures are projected on the surface of a vehicle or object.

The effectiveness of the flexible material and textured surface described herein greatly depends on the fluid flow conditions and precise determination if a boundary layer is laminar, transitional, or turbulent, which depend on several factors, where the most important one is the Reynolds number. Reynolds number is a ratio between the inertial and viscous forces exerted on the fluid. It is represented by the equation: Re=(ρ * ν * x)/μ.

Depending on Reynolds number, the pattern of the fluid flow behavior can be categorized into the following regimes:
Laminar (Re<500,000): The flow moves smoothly in parallel laminates.
Transitional (500,000≤Re≤2,000,000): a region where the flow transitions between laminar and turbulent flow. It generates undulations and starts losing its stability.
Turbulent (Re>2,000,000): The flow is characterized to be chaotic and unpredictable.

In one example, at the standard speed for commercial and military aircraft, critical Re number is reached quickly, meaning that the boundary layer almost always transitions into turbulent flow. In another example, for a car, truck, or airplane critical Re number can also be reached quickly when the object is travelling at cruising speed, thereby achieving this critical number, and increasing skin-friction drag.

Turbulence production within the boundary layer mostly occurs in the regions close to the wall. Reducing skin-friction drag can also provide an indirect increase in other performance parameters, especially in aircraft. For example, decreasing skin-friction results in a need for less lift force, therefore providing the additional benefit of a drop in lift-induced drag, which is typically more dominant in determination of efficiency. In accordance with an example embodiment, the relative fluid velocity to the surface is subsonic flow. The Reynolds number may be, in an example embodiment, between 1×10\hat{ }5 and 4×10\hat{ }6 but may also be effective at higher Reynolds numbers as well.

In accordance with various example embodiments, the surface layer may comprise a compliant wall. Stated another way, the surface layer may be a compliant wall. The compliant wall may be configured to mitigate the growth of boundary layer effects. In an example embodiment, the compliant wall is configured to diminish turbulent boundary layer growth. Compliant walls can be separated into two main categories, active and passive, both of which delay boundary layer transition and flow separation. The former relies on electronic components to maintain the desired skin shape to optimize the skin-friction drag reduction and can be turned off when not needed. They require energy to power the devices and additional control from the computer to ensure that the devices are activated at the right time.

The main advantage of these devices is that they can be customized and turned on when needed to reduce the drag. In contrast, passive compliant walls require no energy expenditure to control the flow and typically involve geometrical modifications, such as vortex generators on aircraft's wings or dimples on a golf ball. These systems are usually less complex in their operation and easier to implement. However, different flow conditions on passive compliant walls can lead to the opposite effect of drag increase.

In an example embodiment, the surface layer is a passive/active compliant wall that combines both active (using energy to reduce drag and activating it only when needed) and passive (not using energy to reduce drag) forms (or components). The surface layer may comprise a balance between both forms of compliant walls, with the benefit of passive compliant walls where no electronics are needed but also the advantage of active compliant walls, where the material adapts to changes in the flow. This balance can be accomplished by using flexible materials such as polymers, which can adapt to different flow conditions and requires no energy to occur.

In accordance with an example embodiment, the flexible material may be formed to have a surface texture of micro-patterning with very small transverse grooves of approximate sinusoidal shape. The flexible material may be configured to delay the transition in the body boundary layer to maintain a laminar flow and reduce the skin-friction drag over the surface. Moreover, the flexible material may be configured to damp any turbulence tendencies resulting from the movement through the fluid.

In particular, the flexible material may be configured to dampen Tollmien-Schlichting (TS) waves. T-S waves are a type of streamwise unstable wave that arises in a bounded shear flow such as flow over a flat-plate or an airfoil. It is one of the common methods by which the laminar boundary layer transitions into turbulent flow. These waves occur when a disturbance, such as sound or disturbance forces, interacts with the leading edge, which results in their slow amplification with increasing downstream distance, and eventually will grow large enough that nonlinearities can occur, and the flow will transition into turbulent flow. In a laminar boundary layer, with random and very small initial disturbance, the instability is expected to occur, known as a Tollmien-Schlichting wave, traveling in the streamwise direction. When transitioning from laminar to turbulent flow, a shear layer develops viscous instability forming the Tollmien-Schlichting waves, which grow into finite amplitude forming unstable waves and hairpin vortices. These vortices, noise and high resistance are the primary features of turbulent flow, and the flexible material may be configured to dampen the TS waves, delaying the onset of turbulent flow or separation. In an example embodiment, the flexible material's flexibility is configured to directly correlate to an increase in the inclination of the hairpin vortices, thus reducing the overall drag coefficient. In accordance with various example embodiments, the flexible material and surface texture described herein may be configured to dampen the T-S waves generated during the transition into the turbulent boundary layer.

In accordance with various example embodiments, the flexible material comprises one or more polymers. In an example embodiment, the flexible material comprises polydimethylsiloxane elastomer and/or ethylene tetrafluoroethylene. The flexible materials may further comprise any materials that cause the surface to adapt to the flow in which they are immersed.

In accordance with an example embodiment, the flexible material comprises polydimethylsiloxane elastomer. Although not so limited, in one example embodiment, the polydimethylsiloxane may have the following properties: Density: 965 kg/m3; Elastic Modulus: 5 MPa; Poisson Ratio: 0.5; Yield Strength: 1.9 MPa; Service Temperature: −40° C.-150° C. Polydimethylsiloxane elastomer is a type of polymer that acts as an elastic solid, like rubber at low temperatures. The loading and unloading stress-strain curves are different, rather the amount of stress exerted on the material will vary based on the degree of strain. The general rule is that increased strain increases stiffness of the material. In an example embodiment, if this elastomer is placed in a mold with a certain shape, and left for curing, the material is configured to behave similar to rubber. Due to its low elastic modulus, it can be easily deformed, stretched, bent, and compressed in all directions. In addition to the above-mentioned mechanical properties, polydimethylsiloxane elastomer may be configured to have excellent transparency, to be low weight, low cost, self-cleaning surface, weather resistant, UV resistant, and non-toxic. This makes the material suitable for the surface of a wing or fuselage, which could facilitate inspections and minimize the maintenance required.

In accordance with an example embodiment, the flexible material comprises ethylene Tetrafluoroethylene (ETFE). Although not so limited, in one example embodiment, the ETFE may have the following properties: Density: 1740 kg/m3; Elastic Modulus: 0.8 GPa; Poisson Ratio: 0.46; Yield Strength: 19 MPa; Service Temperature: −185° C.-150° C.

ETFE, like most fluoropolymers, may be configured to possess excellent properties at high temperatures. It may also be configured to exhibit satisfactory chemical resistance, low skin-friction coefficient when used at a surface in contact with fluid, and to have satisfactory dielectric properties. However, ETFE does not possess high strength as a pure substance, and typically sustains compression better than tension. In an example embodiment, to increase fiber strength, the ETFE flexible material may further comprise fiber glass mixed in to form a composite material to reinforce the ETFE. In one example embodiment, the ETFE flexible material may comprise up to 25% fiberglass, though any suitable percentage of fiberglass material may be used.

In an example embodiment, as a film subject to uniaxial loading, ETFE may be configured to have similar strain characteristics to most polymers. The yield strength of the ETFE flexible material may be configured to be between 13 MPa and 15 MPa. In an example embodiment, the material may develop a gauge line when yield stress is exceeded. The elastic modulus may differ between the initial loading and subsequent loadings past the yield stress. In an example embodiment, the ETFE flexible material may be configured to have excellent durability in water, alkalis, and acids, good durability with UV radiation, and to be self-extinguishing. In addition to the above-mentioned mechanical properties, EFTE may be configured to be high in transparency, low weight, low cost, have a long lifetime, be self-cleaning surface, weather resistant, UV resistant, and fire resistant. In an example embodiment, with these qualities, the material may be configured to be suitable for the surface of a wing or fuselage, which may facilitate inspections and minimize the maintenance required.

In one example embodiment, the flexible material comprises a homogenous mixture of the PMS and ETFE materials. For example, although any suitable proportions may be used, in one example embodiment, the polydimethylsiloxane elastomer is 482.5 grams and the Ethylene Tetrafluoroethylene (ETFE) is 870 grams. Thus, in an example embodiment, the flexible material is a mix of active and passive compliant wall functionality. The flexible material may thus be configured such that the flexible material can return to its initial state when the flow slows, and suitably provides the best of both worlds in the reduction of skin-friction drag over a range of fluid velocities.

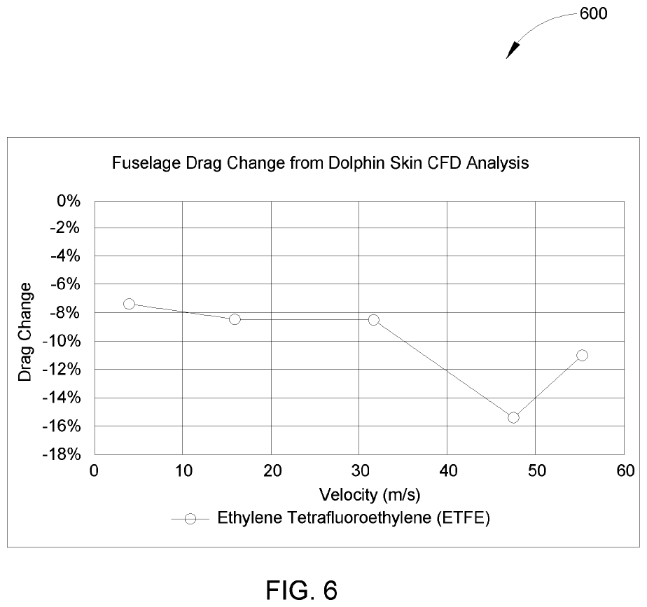

In an example embodiment, for any set riblet size, the skin-friction drag improvement may vary based on the relative speed of the fluid past the surface. For example, and with reference to FIG. 6, the Fuselage Drag Change for an example material on the fuselage of an airplane was modeled, with results showing that the greatest drag change, nearly 16% is obtained between 40 and 50 m/s relative velocity of the fluid to the surface, whereas at lower speeds, the improvement is less than 8%. This analysis was performed using flexible Ethylene Tetrafluoroethylene (ETFE) for the riblet surface, in which a drag reduction of 7 to 16% and was found to be the most beneficial for laminar and transitional Reynolds Numbers of approximately 0.25 to 2 million.

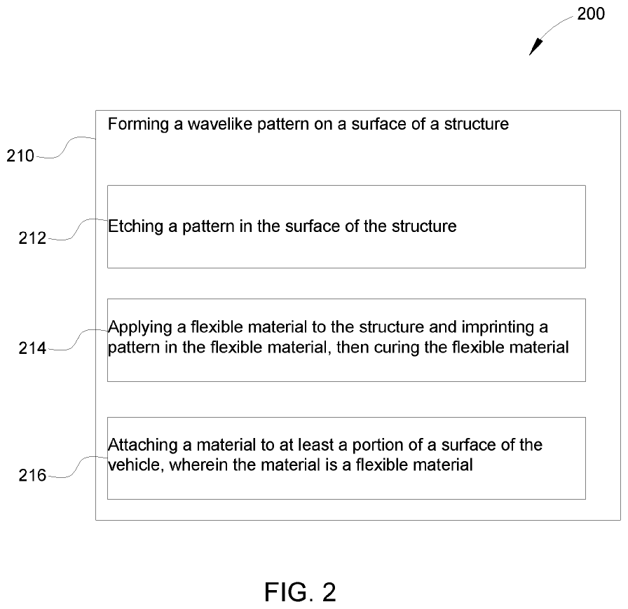

With reference now to FIG. 2, a method 200 may be configured to reduce skin-friction drag on a vehicle that contacts air or water when it travels. In an example embodiment, the method comprises forming a wavelike pattern on a surface of a structure 210. Forming the wavelike pattern may comprise etching a pattern in the structure 212. In another example embodiment, forming the wavelike pattern may comprise applying a flexible material to the structure and imprinting a pattern in the flexible material, then curing the flexible material 214. In another example embodiment, forming the wavelike pattern may comprise attaching a material to at least a portion of a surface of the vehicle, wherein the material is a flexible material 216. In accordance with an example embodiment, the method further comprises forming surface features in a flexible material that contribute to the reduction in skin-friction drag, wherein the step of forming occurs before or after the step of attaching. In accordance with an example embodiment, the flexible material is selected from the group consisting of polydimethylsiloxane elastomer, ethylene tetrafluoroethylene, and combinations thereof.

In accordance with various example embodiments, the surface may be formed using any suitable manufacturing technique. For example, the surface may be formed via Fused Deposition Modeling 3D printing. This method may involve Thermoplastic Polyurethane (TPU) and flexible filaments. In another example embodiment, the surface may be formed using Laser Etching. In this example embodiment, a coating of paint may be provided on the structure, and a laser etcher may be used to remove layers of the paint with depth control. In one example embodiment, the pattern is laser etched into the existing paint. In other embodiments, paint is added and then laser etched. In an example embodiment, the method may comprise three dimensional printing of the pattern on the surface of the structure, or printing the pattern on a surface layer and adhering the surface layer to the structure. Moreover, any suitable method of patterning the flexible material, before or after attachment to the surface of the structure, may be used.

In an example embodiment, the surface may be made of a two-part epoxy hybrid that is mixed and blended for on-site application or as a production component in a manufacturing process making parts to be assembled later. In an example embodiment, a cure component reacts with a base component to set up (harden) and to cause the blended coating film to bond to the surface. In an example embodiment, the flexible material is blended and the cure component is added to start the reaction, and then the flexible material is sprayed or otherwise painted on the surface. In this manner, the method of applying the flexible material is suitable for conforming the flexible material to the surface and is configured to allow for flex of the flexible material during motion. In an example embodiment, 2-part epoxy of base-3 extra additives and curing agent, are blended and cured in a mold with release agent.

In another example embodiment, a surface layer may be made of the flexible material and the surface layer may be adhered to the structure. This may work well in some applications, such as ships, but may not work well for aircraft, as the flexible material may distort at 600 mph. Thus, in various example embodiments, the flexible material components are selected to have the appropriate cured flexibility and hardness for the anticipated velocity and fluid specifications.

In an example embodiment, sheets of pre-textured material may be made and bonded to the structure. In another example embodiment, a portion of a structure can be coated with an uncured polymer (sprayed on, painted on, etc.) and a stereolithographic mold can be shaped into a cylindrical roller that is rolled over the uncured polymer to imprint the structure with a surface feature. Before bonding, the surface of the structure could be sanded to the proper roughness for a strong bond. The type of epoxy can be selected depending on the type of materials to be bonded.

In one example embodiment, the flexible material and surface texture can be retrofit to existing vehicle/object structures. In another example embodiment, the vehicles/objects can be manufactured with the flexible material and/or surface texture in the first instance.

In one example embodiment, the flexible material may be configured to have an inverse relationship between elasticity and a target fluid velocity/medium type. In another example embodiment, certain surfaces may first be treated to address heat build-up, such as, for example applying ceramic filled silicone components in coatings on the skin of an aircraft nose cone for protection of electronics or maintaining controlled temperature inside an aircraft, and then the flexible material/surface texture can be applied to the outer surface of the structure (outer surface of the coating). In another example embodiment, the flexible material may comprise other components for particular applications to achieve additional affects in addition to reducing skin-friction drag. The combined textured flexible material with the other components mixed or layered may be useful for specific applications. Moreover, the textured flexible material may be used in any suitable real world application and adapted to such circumstances.

Several computational models illustrate that the significant improvements of utilizing the flexible material and surface texture described herein. With reference to FIGS. 3A-3F, it is noted that for polydimethylsiloxane elastomer material, FIG. 3A, and EFTE, FIG. 3B, in turbulent flow, the skin-friction drag coefficient significantly drops as Reynolds number increases until as much as about RE=10*10\hat{ }6. Thus, the reduction in skin-friction drag coefficient and overall drag decrease is significant. Drag is significantly reduced in turbulent flow and somewhat reduced in laminar flows. Moreover, the surface is configured to delay turbulent flow onset.

In an example embodiment, experimental modeling has determined that a modified airfoil having the flexible material and surface texture, such as that described herein, exhibited slightly higher lift and slightly lower total drag coefficients at every tested angle of attack. However, the largest improvement was found to be on the CD0, the skin-friction drag coefficient. This increase in lift and decrease in drag resulted in a higher lift-to-drag (L/D) ratio at every angle of attack. This dimensionless metric is a key parameter to aircraft performance, and demonstrates the potential of this new material to increase aerodynamic efficiency and gain more lift with less fuel consumption. In an example embodiment, the modified airfoil may be configured to have a higher L/D ratio ranging from 2% to nearly 14% increase compared to an airfoil with a surface that is not so configured. When applied to an aircraft, this possibility of a 14% increase in L/D ratio means that to achieve the same performance as an unmodified plane, significantly less drag would be produced, and the plane would require less fuel burn to overcome drag forces. Considering average values of % increase in L/D ratio, flow at higher Reynolds number corresponded to greater improvement, indicating that this design would be most successful when applied to large airliners as intended.

As just one specific example, the material and surface texture disclosed herein are configured to have a direct effect on the operating costs and the fuel weight of an aircraft, and this can make room for adding payload to the aircraft. When applied to the Airbus A-380, the total contribution of skin-friction to the total amount of drag in this specific aircraft is around 52%. Using the optimized ridges with parabolic shape (surface texture), the amount of drag reduced in the wing can be around 13%. But if all the aircraft surface areas are covered, the total decrease in drag could be estimated to be around 20%. In this example, before modifications the parameters for the unmodified Airbus A-380 are as follows: Range: 13295 km; Gliding distance: 235 km. After modifications, the parameters for the modified Airbus A-380 are as follows: Range: 15600 km (+17%); and Gliding distance: 275 km (+17%). Thus by applying the compliant wall (textured flexible material), there is a substantial improvement in the performance characteristics of the aircraft. For example, gliding distance is increased by 40 km, and the mission range by 2305 km assuming the aircraft flies at the same speed and the thrust-specific fuel consumption (TSFC) is not changed.

It is estimated that for the Airbus A-380, fuel costs usually account for 40% of the direct operating cost. By effecting an improvement of 14% in aerodynamic efficiency in the cruise phase, one would save around 14% in fuel consumption, leading to a decrease of around 8% in direct operating costs. More importantly, about 3.2 tons of fuel can be replaced by adding the same amount of weight in cargo, or around an additional 20 passengers. Therefore, including the fuel savings the operator is obtaining, the airline could be earning around 9% more per flight, adding significant additional revenue per aircraft per year.

In an example embodiment, the surface is configured to improve skin-friction drag up to 50% (where the surface is configured with the riblet texture as described herein, including with the flexible materials as described herein). Moreover, even without the flexible materials (i.e. with so called rigid materials, the skin-friction drag may be improved by 22%. Accordingly, use of such flexible materials in accordance with the principles disclosed herein corresponds to a total overall drag decrease of around 10-12%.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A vehicle configured for moving through a fluid, the fluid comprising air or water, the vehicle further comprising:
a structure having a surface, wherein the surface is exposed to the fluid as the vehicle moves through the fluid; and
the surface having a surface texture comprising a wave structure transverse to a principal direction of flow of the fluid over the surface, wherein the surface texture is configured to reduce skin-friction drag on the vehicle as it travels through the fluid.

2. The vehicle as recited in claim 1, wherein the wave structure is a parabolic wave structure.

3. The vehicle as recited in claim 1, wherein the structure further comprises a main structure and a surface layer and wherein the surface is formed in the surface layer.

4. The vehicle as recited in claim 3, wherein the surface layer comprises a flexible material.

5. The vehicle as recited in claim 4, wherein the flexible material is selected from the group consisting of polydimethylsiloxane elastomer, ethylene tetrafluoroethylene, and combinations thereof.

6. The vehicle as recited in claim 4, wherein the flexible material includes exterior surface features that contribute to the reduction in skin-friction drag.

7. A material that is configured for use on a surface of a vehicle at a location that contacts a fluid comprising air or water as the vehicle moves for the purpose of reducing skin-friction drag of the vehicle as it travels through the air or water, the material configured to change shape adjusting to increased velocities of the fluid flowing over the material, and configured to receive a surface pattern, wherein the changing shape and surface pattern combined to reduce skin-friction drag of the vehicle as it travels through the air or water.

8. An object configured to have reduced skin-friction drag, the object comprising:
a surface, the surface configured for exposure to a fluid flowing relative to the surface, wherein the surface is configured to reduce skin-friction drag between the surface of the object and the fluid flowing relative to the surface; and
the surface having a surface texture comprising a wave structure transverse to a principal direction of flow of the fluid over the surface.

9. The object as recited in claim 8, wherein the surface comprises a flexible material having the surface texture therein.

10. The object as recited in claim 9, wherein the flexible material is selected from the group consisting of polydimethylsiloxane elastomer, ethylene tetrafluoroethylene, and combinations thereof.

11. The object as recited in claim 9, wherein the flexible material includes exterior surface features that contribute to the reduction in skin-friction drag.

12. A method for reducing skin-friction drag on a vehicle that contacts air or water when it travels, the method comprising forming a wavelike pattern of riblets on a surface of a structure, the wavelike pattern of riblets being transverse to a principal direction of travel of the vehicle, and configured to reduce skin-friction drag on the vehicle.

13. The method of claim 12, further comprising etching the wavelike pattern of riblets in the structure.

14. The method of claim 12, further comprising applying a flexible material to the structure and imprinting the wavelike pattern of riblets in the flexible material, then curing the flexible material.

15. The method of claim 12, further comprising attaching a material to at least a portion of a surface of the vehicle, wherein the material is a flexible material.

16. The method as recited in claim 14, wherein the flexible material is selected from the group consisting of polydimethylsiloxane elastomer, ethylene tetrafluoroethylene, and combinations thereof.

17. The method as recited in claim 12, further comprising forming surface features in a flexible material that contribute to the reduction in skin-friction drag, wherein the step of forming occurs before or after the step of attaching.
